(19) United States
(12) Patent Application Publication
(10) Pub. No.: US 2026/0065062 A1
(43) Pub. Date: Mar. 5, 2026

(54) ADAPTIVE FINE-TUNING OF MACHINE LEARNING MODELS USING GENETIC ALGORITHMS

(71) Applicant: INTUIT INC., Mountain View, CA (US)

(72) Inventors: Siddharth JAIN, Mountain View, CA (US); Sivashanker THIRUCHITTAMPALAM, Toronto (CA); Jonathan LIN, Ontario (CA); Venkat Narayan VEDAM, Mountain View, CA (US)

(21) Appl. No.: 18/816,113

(22) Filed: Aug. 27, 2024

(51) Int. Cl. G06N 3/086

(52) U.S. Cl. CPC G06N 3/086

(57) ABSTRACT

Aspects of the present disclosure relate to automated optimization of machine learning models. Embodiments include determining a set of initial configurations for parameters associated with the machine learning model. Embodiments further include selecting a configuration based on the set of initial configurations and an evolutionary selection process comprising excluding configurations that result in a level of performance for the machine learning model that is below a threshold. Embodiments further include executing the machine learning model using the selected configuration.

### INTRODUCTION

Aspects of the present disclosure relate to techniques for automatically optimizing a machine learning model. In particular, techniques described herein involve using evolution-based parameter modification techniques to optimize the performance of a machine learning model.

### BACKGROUND

A growing number of people, businesses, and organizations around the world use machine learning models. For example, machine learning models may be used to perform tasks such as answering questions, analyzing data, and/or the like.

In developing a machine learning model, optimization techniques may be used to improve the accuracy and/or reduce the computational cost of the model. For example, techniques such as low-rank adaptation may be used to fine-tune the model based on modifying a set of weights that is relatively small compared to the set of all weights in a layer of the model. This low-rank adaptation may save resources compared to techniques that involve fine-tuning for an entire layer. As another example, quantization, or bit reduction, may be performed on the weights within a layer, reducing the overall computational cost subject to a tradeoff in model accuracy. The developers of a machine learning model may manually experiment with different optimization techniques, such as by applying quantization, low-rank adaptation, and/or the like to specific layers of the machine learning model and searching for a configuration that results in a model that is accurate but not overly costly. However, because many possible configurations exist, finding an optimal configuration for a particular task may be prohibitively time-consuming and computationally expensive.

Thus, there is a need in the art for improved techniques for automated optimization of machine learning models.

### BRIEF SUMMARY

Certain embodiments provide an automated method for optimizing a machine learning model. The method generally includes: determining a set of initial configurations for parameters associated with the machine learning model; selecting a configuration based on the set of initial configurations and an evolutionary selection process comprising excluding configurations that result in a level of performance for the machine learning model that is below a threshold; and executing the machine learning model using the selected configuration.

Other embodiments provide processing systems configured to perform the aforementioned method as well as those described herein; non-transitory, computer-readable media comprising instructions that, when executed by one or more processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example of computing components related to automated optimization of machine learning models.

FIG. 2 depicts an example of a machine learning model configured according to a configuration used in an evolutionary selection process.

FIG. 3 depicts an example of an evolutionary selection process.

FIG. 4 depicts an example of operations related to automated optimization of machine learning models.

FIG. 5 depicts an example of a processing system for automated optimization of machine learning models.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide apparatuses, methods, processing systems, and computer-readable mediums for automatically optimizing machine learning models.

According to certain embodiments, a selection process may be used to determine a configuration for a machine learning model that optimizes the performance of the machine learning model. The selection process is based on evolutionary principles, where the “fittest” configurations “survive” and move on to the next generation, or round, of the selection process. As an example, the evolutionary selection process may continue for multiple rounds until a configuration achieves a level of performance over a threshold.

In some embodiments, a configuration comprises a set of values for various parameters associated with a machine learning model. For example, a configuration may include a set of layers to which low-rank adaptation should be applied, a rank for a given low-rank adaptation, a level of quantization for one or more weights of the machine learning model, an activation function to be used in a layer, dropout rates, adapter tuning learning rates, values for other parameters, values for other hyperparameters, and/or the like.

As used herein, low-rank adaptation generally refers to a process through which a machine learning model is fine-tuned by adding the product of two fine-tuned weight matrices to the original weight matrix of a layer of a machine learning model. Fine tuning may involve modifying a matrix of weights (W) for a machine learning model; this modification may be represented by adding a matrix of values (ΔW) to the weights to produce an updated weight matrix (W′). This process may be represented by the equation W′=W+ΔW. In an example of low-rank adaptation, the matrix ΔW may be decomposed into two matrices (A and B) with smaller ranks than ΔW. The two smaller matrices may be fine-tuned, and then the product of the fine-tuned matrices may be added to the original weight matrix. Thus, the low-rank adaptation process may also be represented by the equation W′=W+A×B^{T}, where A and B represent the fine-tuned smaller matrices. Fine-tuning a model through low-rank adaptation can save a significant amount of computational resources compared to fine-tuning an entire matrix of weights. For example, for an M by N weight matrix, performing low-rank adaptation with two fine-tuned matrices of rank R (e.g., matrices with dimensions M by R and R by N) will reduce the number of weights to be trained from M×N to R×(M+N). Thus, when R«M, N, the number of weights to be trained is greatly reduced.

Activation functions are functions that may be used to generate an output prediction for a layer of a machine learning model. Examples of activation functions include rectified linear unit (ReLU) and Gaussian error linear unit (GELU). A configuration may specify an activation function to be used in a machine learning model (or in different layers of the model).

Quantization generally refers to weight bit reduction. For example, a weight may be reduced from eight bits to four bits based on a level of quantization. A configuration may specify a level of quantization for a layer of the machine learning model, and the number of bits for each weight in that layer may be reduced based on the level of quantization. Dropout rates refer to the proportion of neurons that are randomly dropped from a machine learning model during optimization (e.g., to prevent overfitting). Adapter tuning learning rates refer to the step size used to update the weights of a machine learning model during optimization.

Certain embodiments provide that an initial set of configurations may be determined. The initial set of configurations may serve as a starting point for the evolutionary selection process. Each initial configuration may comprise values for a set of parameters relating to a machine learning model. The values may be selected (e.g., randomly) from a range of allowed values for each parameter. For example, a parameter may indicate layers of a machine learning model to which low-rank adaptation should be applied; the range of allowed values for this parameter may span from no layers to every layer.

According to some embodiments, an evolutionary selection process may be used to select a configuration for the machine learning model. For example, each of the initial set of configurations may be used to generate content related to a particular task (e.g., the task may be the task for which the model is being fine-tuned). A configuration may be evaluated based on the performance of the machine learning model while using the configuration. The evolutionary selection process may result in the identification of a high-performing configuration. As an example, a first configuration may cause the machine learning model to perform a task with a certain level of accuracy. A second configuration may cause the machine learning model to perform the task with the same level of accuracy but with a much higher efficiency. Thus, the second configuration may be more likely to “survive” in the evolutionary selection process than the first configuration.

In certain embodiments, the evolutionary selection process comprises excluding configurations based on performance. For example, a set of fifty configurations may be evaluated using the evolutionary selection process. The configurations that result in a level of performance above a threshold may be selected for inclusion in the next round of the evolutionary selection process (e.g., the twenty-five highest performing configurations may be selected). The configurations that resulted in a level of performance below the threshold may be excluded from future rounds of the evolutionary selection process. Certain embodiments provide that a random subset of the high-performing configurations may be selected for inclusion in the next round of the evolutionary selection process. This may involve a roulette-like process where the probability of a configuration being selected is based on the level of performance of the configuration (e.g., higher-performing configurations may have higher probabilities of being selected compared to lower performing configurations). Certain embodiments provide that a configuration may be selected using a tournament-based selection process (e.g., configurations compete against one another in a tournament bracket until a configuration is selected). After multiple rounds of the evolutionary selection process, a configuration for the machine learning model may be selected. In each round, low performers may be excluded while high performers may move on to the next round. The evolutionary selection process may continue until one or more conditions are met. For example, the evolutionary selection process may continue until a target level of performance is reached, a threshold number of rounds are conducted, a threshold number of configurations remain, a performance improvement plateau occurs, and/or the like.

Some embodiments provide that the evolutionary selection process comprises creating new configurations by randomly altering values of one or more parameters within a configuration. For example, a parameter within a high-performing configuration from a previous round of the evolutionary selection process may be randomly altered. If the alteration, or “mutation,” results in a higher level of performance compared to the original configuration, then the mutation may be spread to other configurations. For example, the mutation may provide an indication that increasing the value of a parameter may improve performance; based on this indication, the value of the parameter may be increased in other configurations.

According to certain embodiments, the evolutionary selection process comprises combining parameter values from configurations that result in levels of performance above a threshold. For example, two high-performing configurations may be identified. The parameter values of these high-performing configurations may be mixed together to create one or more new configurations. For example, values for a first subset of parameters may be selected from the first configuration, and values for a second subset of parameters may be selected from the second configuration. If a mutated configuration results in a level of performance above a threshold, the mutated configuration may be included in the next round of the evolutionary selection process.

In some embodiments, the evolutionary selection process comprises iteratively modifying parameter values of configurations and excluding configurations until a configuration is selected that achieves a target level of performance (e.g., until improvements in performance plateau). For example, the mutating, excluding, combining, and/or modifying of configurations may be repeated for several rounds until a configuration results in the target level of performance.

Some embodiments provide that the evolutionary selection process is performed using a machine learning model. For example, a selection machine learning model may be trained to recognize trends in performance based on iterative adjustments to one or more parameter values. Thus, a selection machine learning model may determine a configuration based on identifying values for parameters that maximize the performance of the target machine learning model.

Certain embodiments provide that the level of performance is determined based on evaluating the performance for the machine learning model for multiple tasks. For example, the evolutionary selection process may involve performing two separate tasks for each configuration. The separate tasks may involve separate data sets, separate sets of prompts, separate sets of ground-truth responses, etc. Selecting a configuration based on multiple tasks may prevent overfitting that may otherwise occur due to selecting a configuration based on a single task.

According to some embodiments, the level of performance of a machine learning model is based on a level of accuracy of the machine learning model and a measure of efficiency (e.g., computational cost) of the machine learning model. For example, the accuracy of the machine learning model may be based on comparing a response generated by the machine learning model to a ground-truth correct response. This comparison may be performed by creating embedding representations of the generated response and the ground-truth response and then using semantic similarity algorithms (e.g., cosine similarity) to determine the level of similarity between the responses. As another example, the comparison may be based on determining a match between text (e.g., determining that short answers or multiple choice answers match). In some embodiments, n-grams may be used to determine a level of textual similarity between responses. In certain embodiments, the measure of computational cost may be determined based on the amount of computational resources used by the machine learning model.

In certain embodiments, the level of performance is based on a tradeoff between efficiency and accuracy. For example, in some applications, a user may value efficiency more than accuracy. In such cases, efficiency may have a higher weight relative to accuracy. In other cases, the user may value efficiency less. The performance may be calculated based on an indication from a user regarding the importance of accuracy relative to efficiency.

Some embodiments provide that the evolutionary selection process may be performed based on user feedback. For example, the evolutionary selection process may select a configuration that results in a high level of performance. This configuration may be deployed and the machine learning model may be executed. User feedback may indicate that the level of performance is not satisfactory, a new configuration should be selected, and/or the like. Based on this feedback, a new configuration may be selected (e.g., based on a different/broader task).

Embodiments of the present disclosure provide numerous technical and practical effects and benefits. For example, techniques disclosed herein enable automated selection of parameter values for a machine learning model that achieve a target balance of accuracy and resource-efficiency. Thus, parameters (such as layers on which to apply low-rank adaptation) may be determined without the need for painstaking and time-consuming manual labor in a manner that was not possible in an automated manner prior to the techniques described herein. Additionally, techniques disclosed herein allow for greater efficiency in selecting a set of parameter values that achieve a desired level of performance. For example, selecting a random set of parameter values for a configuration may fail to yield a configuration that performs well, and simple trial and error may require an excessive amount of testing (e.g., a large amount of configurations may be implemented and used to generate responses in order to select a configuration). Thus, by using the evolutionary techniques described herein, a configuration for a machine learning model may be selected that achieves a desired level of performance (e.g., accuracy and resource-efficiency), and the selection process itself may require less time and computing resources to perform than alternative computer-implemented techniques (e.g., random parameter selection and simple trial and error).

### Example of Computing Components Related to Automated Optimization of Machine Learning Models

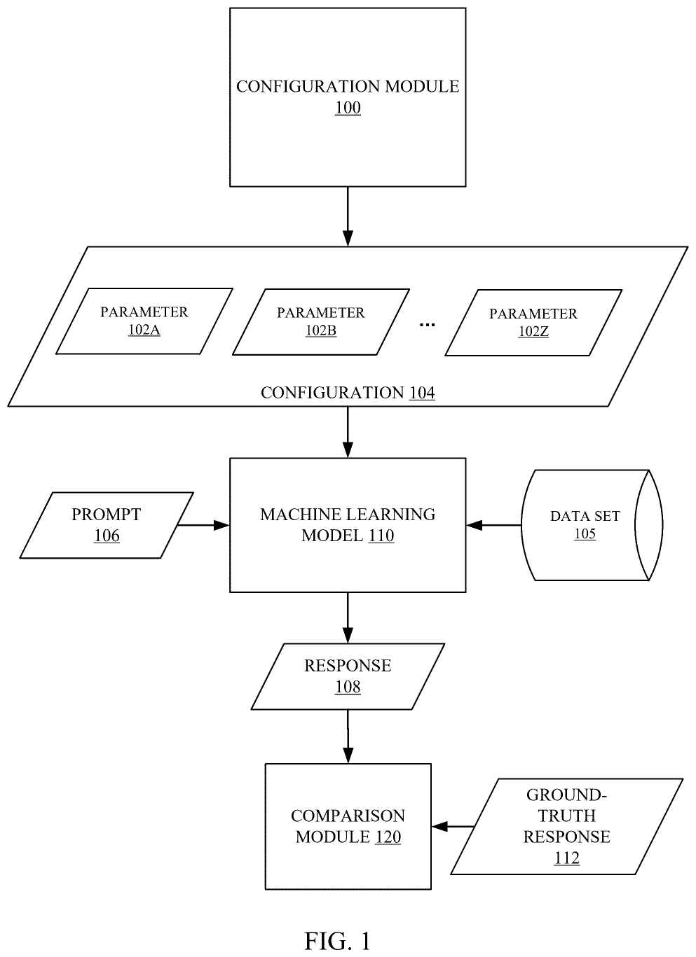

FIG. 1 depicts an example of computing components related to automated optimization of machine learning models.

A configuration module 100 may determine multiple configurations for a machine learning model 110. The machine learning model 110 may be any type of machine learning model, such as a neural network. In some embodiments, the machine learning model 110 is a transformer model. The configurations may comprise values for one or more parameters, such as a set of layers of the machine learning model 110 to which low-rank adaptation (LoRA) should be applied, a rank for a given low-rank adaptation, a level of quantization for one or more weights of the machine learning model 110, an activation function to be used in a layer, dropout rates, adapter tuning learning rates, values for other parameters, values for other hyperparameters, and/or the like. Configuration model 100 may determine an initial set of configurations based on assigning random values to parameters for each configuration. The random values may be values within an allowed range. For example, an allowed range for dropout rate may be between 0.1 and 0.9, while an allowed range for an activation function may be any function from the list of all available activation functions.

Configuration 104 may be representative of a configuration that is implemented in machine learning model 110. Configuration 104 comprises values for parameters 102A-Z. Parameter 102A may correspond to the layers of machine learning model 110 to which LoRAs should be applied. For example, the value of parameter 102A may specify that LoRAs should be applied to layers one, two, four, and six of machine learning model 110. Parameter 102B may correspond to a level of quantization for machine learning model 110 or a level of quantization for the different layers of machine learning model 110. For example, parameter 102B may specify that the weights for the entire model should be reduced to four bits. As another example, parameter 102B may specify that the weights for one layer should be reduced to eight bits, the weights for another layer should be reduced to four bits, and so on. Parameter 102Z may correspond to a value for a parameter, hyperparameter, and/or the like (e.g., temperature or adapter tuning learning rate). These parameters are included as an example of parameters that may be contained in a configuration, and other configurations containing other parameters are contemplated.

To select a configuration for use with machine learning model 110, the configurations may be implemented in machine learning model 110 and machine learning model 110 may be used to perform a task. As part of the selection process, machine learning model 110 may be configured according to configuration 104. This may comprise applying LoRAs to the layers of machine learning model 110 specified by the value of parameter 102A and/or quantizing the weights of machine learning model 110 as specified by the value of parameter 102B.

Once configured, machine learning model 110 may be used to perform a task. As shown in FIG. 1, the task may comprise generating a response 108 to a prompt 106 based on information contained within data set 105. The response 108 may comprise a natural language response, a selection of one or more possible answer choices, and/or the like. The task may generally be any type of task a machine learning model is capable of performing, and the response may generally be any type of response a machine learning model is capable of generating/selecting. Different tasks (e.g., different prompts and/or datasets) may be used in the same evolutionary selection process to prevent overfitting to a particular task.

Comparison module 120 may compare the response 108 to the ground-truth response 112. The ground-truth response 112 may be a response that has been confirmed to be correct (e.g., by a user of a machine learning model optimization system or another entity). Comparison module 120 may comprise an embedding model that is configured to generate embedding representations of responses. An embedding generally refers to a vector representation of an entity that represents the entity as a vector in n-dimensional space such that similar entities are represented by vectors that are close to one another in the n-dimensional space. The embedding model may comprise a neural network or other type of machine learning model that learns a representation (embedding) for an entity through a training process that trains the neural network based on a data set, such as a plurality of features of a plurality of entities. In one example, the embedding model comprises a Bidirectional Encoder Representations from Transformer (BERT) model, which involves the use of masked language modeling to determine embeddings. In a particular example, the embedding model comprises a Sentence-BERT model. In other embodiments, the embedding model may involve embedding techniques such as Word2Vec and GloVe embeddings. These are included as examples, and other techniques for generating vector representations of entities (such as embedding representations) are possible.

The comparison module 120 may compare an embedding representation of response 108 to an embedding representation of ground truth response 112. This comparison may be performed by calculating the dot product between two embedding vectors, determining the cosine similarity, Jaccard similarity, Euclidean distance, or Levenshtein distance between two embedding vectors, using other types of semantic similarity algorithms, and/or using other techniques for comparing two vectors as known in the art. In some embodiments, the comparison is performed by a machine learning model that is trained to compare embedding vectors.

The comparison module 120 may compare the response 108 and the ground-truth response 112 using a text-based comparison. For example, the text-based comparison may comprise confirming that the text of response matches the text of ground-truth response 112. The text-based comparison may involve n-gram representations of the responses (n-grams are generally groups of up to n consecutive words or characters, where n is a positive integer).

The comparisons performed by the comparison module 120 may be used to determine the accuracy of the machine learning model 110 using configuration 104. For example, if response 108 closely matches ground-truth response 112, it may be determined that the configuration 104 results in a high level of accuracy. If the responses do not closely match, it may be determined that the configuration 104 results in a low level of accuracy.

Accuracy may be one component used in evaluating the performance of the machine learning model 110 for configuration 104. Another component may be efficiency. For example, configuration 104 may lead to an accurate response 108 that required an excessive amount of computing resources to produce. Because the response 108 required an excessive amount of resources to produce, it may be determined that configuration 104 resulted in a low level of performance even though the response 108 was accurate. As another example, configuration 104 may lead to an accurate response 108 that required a relatively small amount of computing resources to generate. As a result, it may be determined that configuration 104 resulted in a high level of performance.

The level of performance may be determined based on a tradeoff between efficiency and accuracy. For example, the performance may be calculated based on an indication from a user regarding the importance of accuracy relative to efficiency. The relationship between performance, accuracy, and efficiency may be represented by the equation, Performance=Accuracy−(T×Efficiency), where T represents the tradeoff coefficient balancing accuracy and efficiency. The tradeoff coefficient may be set by a user, or the tradeoff coefficient may be set based on an input provided by a user (e.g., a response to a question regarding the importance of efficiency relative to accuracy).

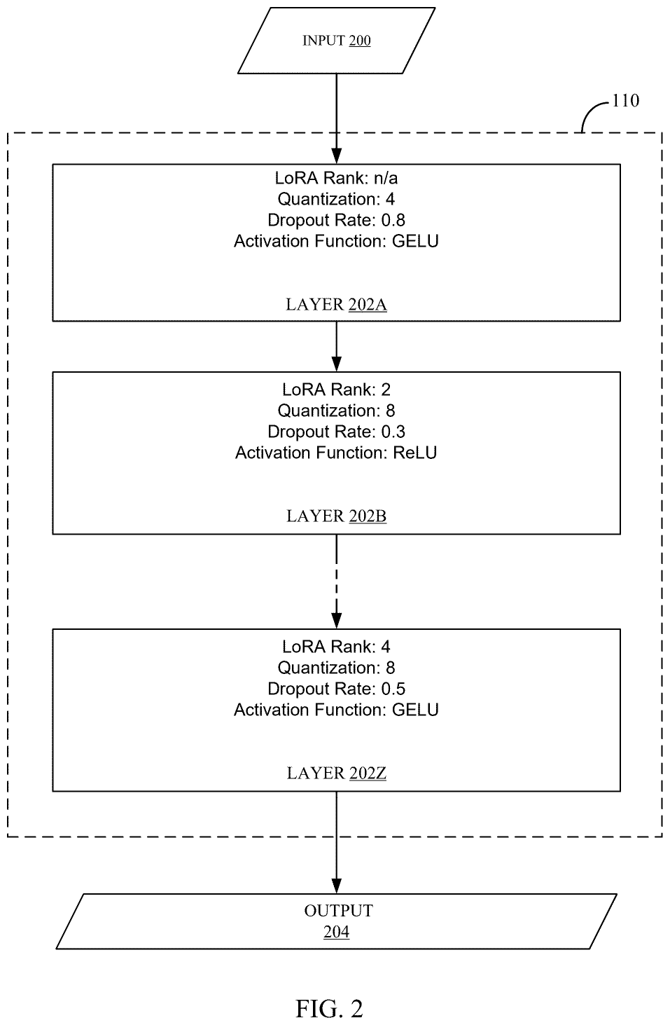

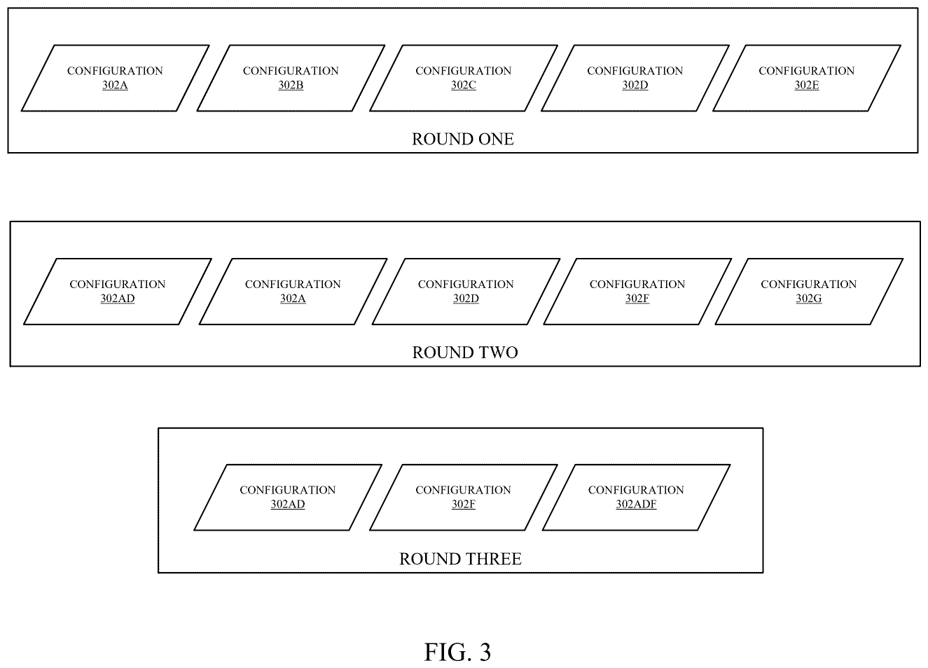

If it is determined that configuration 104 resulted in a high level of performance, configuration 104 may be selected as the configuration for machine learning model 110, or configuration 104 may be included in a subsequent round of an evolutionary selection process, as discussed in further detail below with respect to FIG. 2 and FIG. 3. If it is determined that configuration 104 resulted in a low level of performance, configuration 104 may be excluded from a subsequent round of the evolutionary selection process.

A selected configuration may be deployed in the machine learning model 110, and the machine learning model 110 may be executed (e.g., to perform a task for which it is trained, such as generating one or more outputs in response to one or more inputs). Once executed, user feedback may be received regarding the performance of the machine learning model. The feedback may be received via a user interface through which a user interacts with the machine learning model 110. For example, the feedback may be a response to a question regarding the performance of the machine learning model 110, such as a selection of a multiple choice answer or a natural language response. If the feedback indicates that the level of performance is not satisfactory, a new configuration may be selected. For example, the evolutionary selection process may be repeated to select a new configuration. As another example, if the old configuration was previously selected randomly from a group of high-performing configurations, a new configuration may be selected from the group. In another example, the highest or next-highest performing configuration may be selected as the new configuration. Subsequently, machine learning model 110 may be executed using the newly-selected configuration.

### Example of a Machine Learning Model Configured According to a Configuration Used in an Evolutionary Selection Process

FIG. 2 depicts an example of a machine learning model 110 configured according to a configuration used in an evolutionary selection process.

The configuration comprises values for parameters associated with the machine learning model 110. For example, one parameter of the configuration is LoRA rank for layer 202A. As shown in FIG. 2, low-rank adaptation is not used for layer 202A, so the value for the LoRA rank parameter is not applicable. The value for the quantization parameter is four, meaning that the weights in layer 202A are reduced to four bits. The value for the dropout rate parameter is 0.8, meaning that the dropout rate for layer 202A is 0.8. The value for the activation function parameter is “GELU,”meaning that a Gaussian error linear unit function is used for layer 202A.

For layer 202B, low-rank adaptation is applied using decomposition matrices of rank two. The value for the quantization parameter is eight, meaning that the weights in layer 202B are reduced to eight bits. The value for the dropout rate parameter is 0.3, meaning that the dropout rate for layer 202B is 0.3. The value for the activation function parameter is “ReLU,” meaning that a rectified linear unit function is used for layer 202B. For layer 202Z, low-rank adaptation is applied using decomposition matrices of rank four. The value for the quantization parameter is eight, meaning that the weights in layer 202Z are reduced to eight bits. The value for the dropout rate parameter is 0.5, meaning that the dropout rate for layer 202Z is 0.5. The value for the activation function parameter is “GELU,” meaning that a Gaussian error linear unit function is used for layer 202Z.

As mentioned above, the configuration shown in FIG. 2 may be used in an evolutionary selection process. For example, once configured according to the configuration, the machine learning model 110 may be used to generate an output 204 based on an input (e.g., by processing the input 200 through the layers 202A-Z). If the performance of the machine learning model 110 is determined to be above a threshold, as described above with respect to FIG. 1, the configuration may be included in subsequent rounds of the selection process. If the performance is below a threshold, the configuration may be excluded.

As part of the selection process, one or more parameters of the configuration shown in FIG. 2 may be randomly altered to assess the impact of the alteration. For example, the dropout rate parameter for layer 202A may be changed from 0.8 to 0.7. If this change improves performance of the machine learning model 110, then the original configuration may be excluded and the altered configuration may be included in subsequent rounds (and vice versa if the alteration leads to a decrease in performance).

As part of the selection process, if the configuration shown in FIG. 2 results in a level of performance above a threshold, one or more parameter values of the configuration may be merged with parameter values of other high-performing configurations to form new configurations. For example, the new configuration may comprise the parameter values for layer 202A shown in FIG. 2 with parameter values for layer 202B that were used in another high-performing configuration.

The parameters and parameter values shown in FIG. 2 correspond to individual layers of the machine learning model 110. In other embodiments, the parameters may have different levels of granularity. For example, a quantization parameter in a configuration may specify the level of quantization for an entire model, and not just a layer of the model.

### Example of an Evolutionary Selection Process

FIG. 3 depicts an example of an evolutionary selection process.

In the first round of the evolutionary selection process, a set of configurations 302A-E may be generated (e.g., by assigning random values within an allowed range to each of the parameters). A machine learning model may be configured according to each configuration 302A-E, and then the performance of the machine learning model may be evaluated for each configuration 302A-E. Low performing configurations may be excluded from subsequent rounds of the evolutionary selection process. As shown in FIG. 3, configurations 302B, 302C, and 302E were excluded from round two of the evolutionary selection process. Configurations 302A and 302D were selected for inclusion in round two. One or more of configurations 302B, 302C, and 302E may be configurations that resulted in a low level of performance. According to some embodiments, one or more of configurations 302B, 302C, and 302E may have resulted in a high level of performance but were randomly excluded (e.g., through a roulette-based process). Configurations 302A and 302D may have resulted in a high level of performance.

The configurations may be included/excluded in subsequent rounds based on the level of performance of the machine learning model reaching/failing to reach a threshold. The threshold may be objective (e.g., configurations that achieve a performance score over a threshold score may be included) or relative (e.g., the threshold may require configurations to be in the top half of performers to be selected). As another example, configurations may be included/excluded using a tournament style selection. Pairs of configurations may be compared against each other and the highest performer of the pair may be included in the next round. Then in the next round, pairs may be evaluated using the same task or a different task (e.g., different inputs and/or different data sets may be used). In another example, the including/excluding may be roulette-based, such that the probability of a configuration being randomly included in the next round is based on the measured level of performance of the configuration. Multiple sets of configurations from a high-performing group of configurations may be otherwise randomly selected for a subsequent round. The selection process may continue until a configuration achieves a level of performance above a threshold, until a threshold number of configurations have been excluded, or until improvements in performance plateau (e.g., the performance fails to improve for a threshold number of rounds). In some embodiments, at the end of the evolutionary selection process, the highest scoring configuration is selected for deployment in the machine learning model, while other embodiments provide that a random configuration is selected for deployment from among the remaining configurations (e.g., using a roulette-based process, as described above).

As shown in FIG. 3, round two of the evolutionary selection process includes configurations 302A and 302D from round one. Round two also includes new configurations based on configurations 302A and 302D. New configuration 302AD represents a configuration that was created by combining parameters of configuration 302A and 302D. New configuration 302F represents a configuration that was created by randomly altering one or more parameter values of configuration 302A. New configuration 302G represents a configuration that was created by randomly altering one or more parameter values of configuration 302D.

As shown in FIG. 3, round three of the evolutionary selection process includes configurations 302AD and 302F from round two. New configuration 302ADF represents a configuration that was created by combining parameters of configuration 302AD and 302F. One of the configurations may be deployed for used in the machine learning model, and the machine learning model may be executed.

In some embodiments, the evolutionary selection process may be performed by a machine learning model. For example, a machine learning model may be trained to adjust parameter values based on changes in performance that are caused by the adjustments.

### Example Operations Related to Automated Optimization of Machine Learning Models

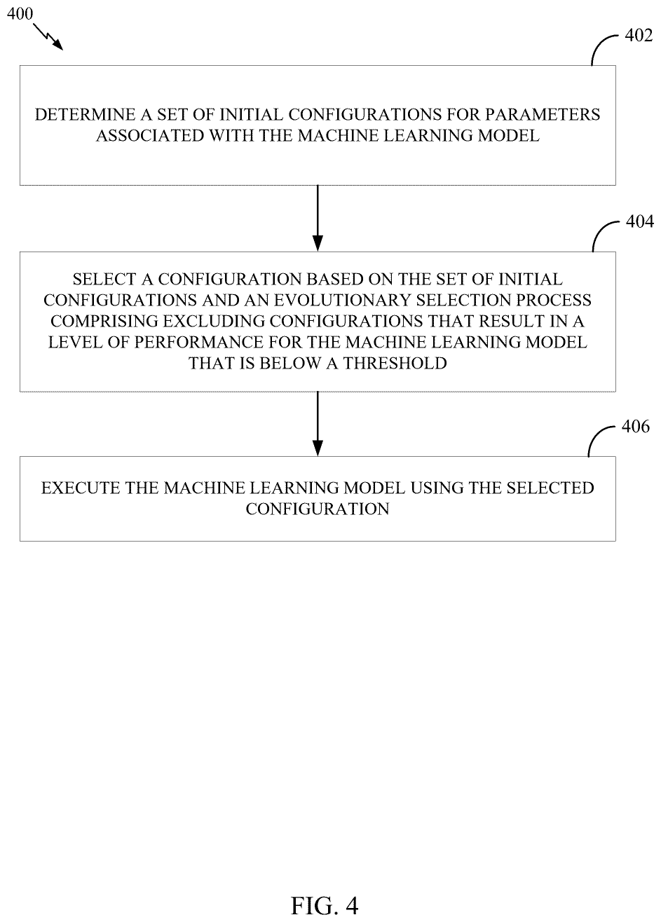

FIG. 4 depicts example operations 400 related to automated optimization of machine learning models. For example, operations 400 may be performed by one or more of the components described with respect to FIG. 1.

Operations 400 begin at step 402 with determining a set of initial configurations for parameters associated with the machine learning model. In some embodiments, the parameters comprise one or more of: layers of the machine learning model to which a low-rank adaptation is applied; a rank for a given low-rank adaptation; a level of quantization for one or more weights of the machine learning model; an activation function to be used in a layer; dropout rates; or adapter tuning learning rates.

Operations 400 continue at step 404 with selecting a configuration based on the set of initial configurations and an evolutionary selection process comprising excluding configurations that result in a level of performance for the machine learning model that is below a threshold. In certain embodiments, the evolutionary selection process further comprises creating new configurations based on randomly altering values of one or more parameters of a configuration in the set of initial configurations. Certain embodiments provide that the evolutionary selection process further comprises combining parameter values from configurations that achieve a level of performance that is above a threshold. Some embodiments provide that the evolutionary selection process further comprises selecting values for a parameter that result in relatively high levels of performance for the machine learning model compared to other values. In certain embodiments, the evolutionary selection process further comprises iteratively modifying parameter values of configurations and excluding configurations that result in levels of performance for the machine learning model that are below a threshold until a configuration is selected that achieves a target level of performance. According to certain embodiments, the evolutionary selection process further comprises, after each iteration, randomly selecting a set of configurations and excluding configurations that are not in the randomly selected set of configurations. Some embodiments provide that the evolutionary selection process is performed using an additional machine learning model that is trained to select parameter values based on levels of performance associated with the parameter values. In certain embodiments, the evolutionary selection process is based on evaluating the performance of the machine learning model for multiple tasks. Certain embodiments provide that the level of performance is determined based on a level of accuracy of the machine learning model and a measure of computational cost of the machine learning model. In some embodiments, the level of accuracy of the machine learning model is determined based on comparing a response generated by the machine learning model to a ground truth response.

Operations 400 continue at step 406 with executing the machine learning model using the selected configuration.

According to some embodiments, user feedback is received based on the selected configuration. Based on the user feedback, the evolutionary selection process may be repeated.

### Example of a Processing System for Automated Optimization of Machine Learning Models

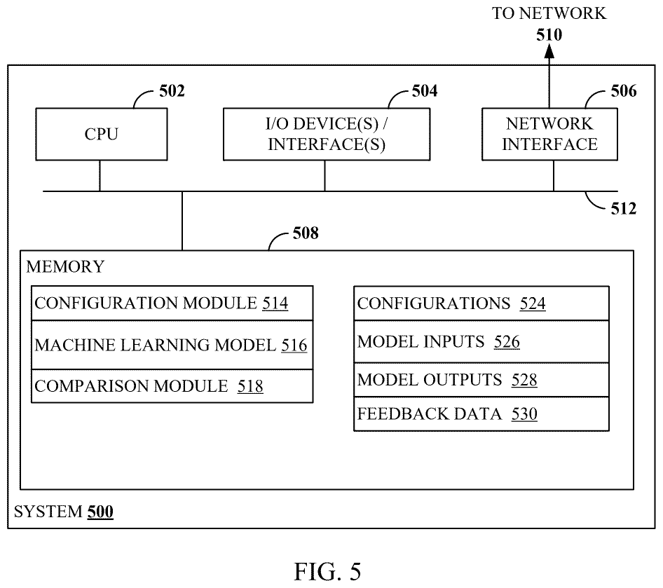

FIG. 5 illustrates an example system 500 with which embodiments of the present disclosure may be implemented. For example, system 500 may be configured to perform operations 400 of FIG. 4 and/or to implement one or more components as in FIG. 1 or FIG. 2.

System 500 includes a central processing unit (CPU) 502, one or more I/O device interfaces that may allow for the connection of various I/O devices 504 (e.g., keyboards, displays, mouse devices, pen input, etc.) to the system 500, network interface 506, a memory 508, and an interconnect 512. It is contemplated that one or more components of system 500 may be located remotely and accessed via a network 510. It is further contemplated that one or more components of system 500 may comprise physical components or virtualized components.

CPU 502 may retrieve and execute programming instructions stored in the memory 508. Similarly, the CPU 502 may retrieve and store application data residing in the memory 508. The interconnect 512 transmits programming instructions and application data, among the CPU 502, I/O device interface 504, network interface 506, and memory 508. CPU 502 is included to be representative of a single CPU, multiple CPUs, a single CPU having multiple processing cores, and other arrangements.

Additionally, the memory 508 is included to be representative of a random access memory or the like. In some embodiments, memory 508 may comprise a disk drive, solid state drive, or a collection of storage devices distributed across multiple storage systems. Although shown as a single unit, the memory 508 may be a combination of fixed and/or removable storage devices, such as fixed disc drives, removable memory cards or optical storage, network attached storage (NAS), or a storage area-network (SAN).

As shown, memory 508 includes configuration module 514, machine learning model 516, and comparison module 518. Configuration module 514 may be representative of configuration module 100 of FIG. 1. In some embodiments, machine learning model 516 may be representative of machine learning model 110 of FIG. 1 and FIG. 2. Comparison module 518 may be representative of comparison module 120 of FIG. 1.

Memory 508 further comprises configurations 524, which may correspond to configuration 104 of FIG. 1 or one or more of the configurations shown in FIG. 2 and FIG. 3. Memory 508 further comprises model inputs 526 which may correspond to prompt 106 or data within data set 105 of FIG. 1 or input 200 of FIG. 2. Memory 508 further comprises model outputs 528, which may include response 108 of FIG. 1 or output 204 of FIG. 2. Memory 508 further comprises feedback data 530, which may correspond to feedback received from a user of machine learning model 110 of FIG. 1 and FIG. 2.

It is noted that in some embodiments, system 500 may interact with one or more external components, such as via network 510, in order to retrieve data and/or perform operations.

### Additional Considerations

The preceding description provides examples, and is not limiting of the scope, applicability, or embodiments set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The preceding description is provided to enable any person skilled in the art to practice the various embodiments described herein. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and other operations. Also, “determining” may include receiving (e.g., receiving information), accessing (e.g., accessing data in a memory) and other operations. Also, “determining” may include resolving, selecting, choosing, establishing and other operations.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

A processing system may be implemented with a bus architecture. The bus may include any number of interconnecting buses and bridges depending on the specific application of the processing system and the overall design constraints. The bus may link together various circuits including a processor, machine-readable media, and input/output devices, among others. A user interface (e.g., keypad, display, mouse, joystick, etc.) may also be connected to the bus. The bus may also link various other circuits such as timing sources, peripherals, voltage regulators, power management circuits, and other types of circuits, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media, such as any medium that facilitates transfer of a computer program from one place to another. The processor may be responsible for managing the bus and general processing, including the execution of software modules stored on the computer-readable storage media. A computer-readable storage medium may be coupled to a processor such that the processor can read information from, and write information to, the storage medium. In the alternative, the storage medium may be integral to the processor. By way of example, the computer-readable media may include a transmission line, a carrier wave modulated by data, and/or a computer readable storage medium with instructions stored thereon separate from the wireless node, all of which may be accessed by the processor through the bus interface. Alternatively, or in addition, the computer-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module, it will be understood that such functionality is implemented by the processor when executing instructions from that software module.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method of automatically optimizing a machine learning model, comprising:
determining a set of initial configurations for parameters associated with the machine learning model;
selecting a configuration based on the set of initial configurations and an evolutionary selection process comprising excluding configurations that result in a level of performance for the machine learning model that is below a threshold; and
executing the machine learning model using the selected configuration.

2. The method of claim 1, wherein the parameters comprise one or more of:
layers of the machine learning model to which a low-rank adaptation is applied;
a rank for a given low-rank adaptation;
a level of quantization for one or more weights of the machine learning model;
an activation function to be used in a layer;
dropout rates; or
adapter tuning learning rates.

3. The method of claim 1, wherein the evolutionary selection process further comprises creating new configurations based on randomly altering values of one or more parameters of a configuration.

4. The method of claim 1, wherein the evolutionary selection process further comprises combining parameter values from configurations that achieve a level of performance that is above a threshold.

5. The method of claim 1, wherein the evolutionary selection process further comprises selecting values for a parameter that result in relatively high levels of performance for the machine learning model compared to other values.

6. The method of claim 1, wherein the evolutionary selection process further comprises iteratively modifying parameter values of configurations and excluding configurations that result in levels of performance for the machine learning model that are below a threshold until a configuration is selected that achieves a target level of performance.

7. The method of claim 6, wherein the evolutionary selection process further comprises, after each iteration, randomly selecting a set of configurations and excluding configurations that are not in the randomly selected set of configurations.

8. The method of claim 6, wherein the evolutionary selection process is performed using an additional machine learning model that is trained to select parameter values based on levels of performance associated with the parameter values.

9. The method of claim 1, wherein the evolutionary selection process is based on evaluating performance of the machine learning model for multiple tasks.

10. The method of claim 1, wherein the level of performance is determined based on a level of accuracy of the machine learning model and a measure of computational cost of the machine learning model.

11. The method of claim 10, wherein the level of accuracy of the machine learning model is determined based on comparing a response generated by the machine learning model to a ground truth response.

12. The method of claim 1, wherein user feedback is received based on the selected configuration, wherein the evolutionary selection process is repeated based on the feedback.

13. A system for automatically optimizing a machine learning model, comprising:
one or more processors; and
a memory comprising instructions that, when executed by the one or more processors, cause the system to:
determine a set of initial configurations for parameters associated with the machine learning model;
select a configuration based on the set of initial configurations and an evolutionary selection process comprising excluding configurations that result in a level of performance for the machine learning model that is below a threshold; and
execute the machine learning model using the selected configuration.

14. The system of claim 13, wherein the parameters comprise one or more of:
layers of the machine learning model to which a low-rank adaptation is applied;
a rank for a given low-rank adaptation;
a level of quantization for one or more weights of the machine learning model;
an activation function to be used in a layer;
dropout rates; or
adapter tuning learning rates.

15. The system of claim 13, wherein the evolutionary selection process further comprises creating new configurations based on randomly altering values of one or more parameters of a configuration.

16. The system of claim 13, wherein the evolutionary selection process further comprises combining parameter values from configurations that achieve a level of performance that is above a threshold.

17. The system of claim 13, wherein the evolutionary selection process further comprises selecting values for a parameter that result in relatively high levels of performance for the machine learning model compared to other values.

18. The system of claim 13, wherein the evolutionary selection process further comprises iteratively modifying parameter values of configurations and excluding configurations that result in levels of performance for the machine learning model that are below a threshold until a configuration is selected that achieves a target level of performance.

19. The system of claim 18, wherein the evolutionary selection process is performed using an additional machine learning model that is trained to select parameter values based on levels of performance associated with the parameter values.

20. A non-transitory computer readable medium comprising instructions that, when executed by one or more processors of a computing system, cause the computing system to:
determine a set of initial configurations for parameters associated with the machine learning model;
select a configuration based on the set of initial configurations and an evolutionary selection process comprising excluding configurations that result in a level of performance for the machine learning model that is below a threshold; and
execute the machine learning model using the selected configuration.
